(19) United States
(12) Patent Application Publication
(10) Pub. No.: US 2013/0155934 A1
(43) Pub. Date: Jun. 20, 2013

(54) NETWORK WITH SECONDARY CONTROL CHANNEL

(71) Applicant: Matthew Johnson, Spokane, WA (US)

(72) Inventor: Matthew Johnson, Spokane, WA (US)

(73) Assignee: ITRON, INC., Liberty Lake, WA (US)

(21) Appl. No.: 13/328,461

(22) Filed: Dec. 16, 2011

(51) Int. Cl. H04W 4/00; H04H 20/71; H04B 7/14

(52) U.S. Cl. 370/312; 370/328; 370/315

(57) ABSTRACT

Disclosed are apparatus and methodology for providing communications in an Advanced Metering Infrastructure (AMI). Information including utility consumption information is transmitted from network endpoints to a central facility using a first communications channel, generally within an ISM band using relatively lower power transmitters operating in accordance with 47 CFR, Part 15. Commonly applicable information (for example, time signals and instructions destined for multiple of the endpoints) is transmitted over a second communications channel in frequency bands other than ISM bands using relatively higher power levels than are permitted under Part 15. Network endpoints and the first and second communications channels may be utilized in either of a mesh network or a star network.

### FIELD OF THE SUBJECT MATTER

The presently disclosed subject matter relates to network communications generally, and further including communications within an Advanced Metering Infrastructure (AMI). More particularly, the presently disclosed subject matter relates to the provision of secondary communications channels within AMI networks.

### BACKGROUND OF THE SUBJECT MATTER

Advanced Metering Infrastructure (AMI) networks are complex arrangements involving multiple components that, of necessity, must be provided with reliable communications channels therebetween in order to provide the metering services for which they are designed. Such networks generally are directed from a central facility by way of managements systems and data collection systems. In general, such systems are coupled by various communications means to metrology devices (endpoints), for example, such as utility meters, located at various consumer locations, and are designed to transmit consumption related information such as information related to the amount of electricity, water, oil, gas, etc. used by a consumer. In some instances, a system of cell relays and repeaters may be employed to form networks to transmit information to and from the various metrology devices and the central facility.

As such systems grow in size, communications channels may become overloaded such that additional equipment must be provided. In addition, as the systems become larger, certain of the metrology devices (endpoints) may find themselves installed at locations at the very edge of reliable communications distances due at least in part to the limitations imposed on mass produced devices with respect to cost and consequent impairment in receive-sensitivity for endpoints. Because of such constraints and other implementation requirements, improving the downlink capabilities in endpoints is not necessarily a practical approach to an efficient solution.

While various implementations of advanced metering systems have been developed, and while various communications mechanisms have been provided, no design has emerged that generally encompasses all of the desired characteristics as hereafter presented in accordance with the subject technology.

### SUMMARY OF THE SUBJECT MATTER

In view of the recognized features encountered in the prior art and addressed by the presently disclosed subject matter, improved apparatus and methodology for providing enhanced network communications have been provided.

The presently disclosed subject matter relates in general to a network comprising a central communications facility and a plurality of endpoints. The central communications facility and endpoints may communicate among each other by way of a primary communications channel and with a secondary communications channel employed for transmitting information commonly applicable to the plurality of endpoints.

In selected embodiments of the presently disclosed subject matter, a cell relay may be provided that forms with the plurality of endpoints a mesh network with the cell relay operating as a control unit for a cell of the mesh network. Alternatively, the presently disclosed subject matter may provide a central controller that forms with the plurality of endpoints a star network. The cell relay or central controller in some instances may communicate with the plurality of endpoints using the primary communications channel. In certain embodiments, communication over the primary communications channel may be conducted within an industrial, scientific and medical (ISM) frequency band (using a relatively lower power transmitter, as well known to those of ordinary skill in the art). In other embodiments, communications over the secondary communications channel may be conducted using a relatively higher power transmitter operable at power levels above those permitted in ISM frequency bands.

In selected embodiments, the high power transmitter operating on the secondary communications channel may be housed within the cell relay or central controller. In other presently disclosed embodiments, the higher power transmitter operating on the secondary communications channel may be housed at a separate transmitter site.

In some of the presently disclosed embodiments, the transmitter operating on the secondary channel may transmit time related signals, while in other embodiments, the transmitter operating on the secondary channel may also transmit signals including instructions for the endpoints to transmit consumption related signals.

In some presently disclosed embodiments, at least some of the endpoints may be respectively associated with metering devices, and the network may comprise an Advanced Metering Infrastructure (AMI). In some of such embodiments, such metering devices may comprise at least one of electricity, gas, water, and oil meters.

In other presently disclosed exemplary embodiments, at least some of such endpoints may be respectively associated with electricity metering devices not dependent on battery power for operation, and an associated secondary communications channel may be used for unicast and multicast communications for transmitting rates and performing demand response events.

The presently disclosed subject matter also equally relates to corresponding and/or associated methods for providing network communications. According to such presently disclosed methods in general, utility consumption related data may be transmitted over a first communications channel among a plurality of network endpoints and a central facility, and commonly applicable information may be transmitted to the plurality of endpoints over a secondary communications channel.

In selected of the embodiments of such methods, transmission of both utility consumption and commonly applicable information may be conducted by way of a cell relay. According to some of such embodiments, an exemplary such cell relay may transmit utility consumption information from the plurality of endpoints to the central facility using the primary communications channel and transmit commonly applicable information to the plurality of endpoints using the secondary channel.

In further presently disclosed exemplary embodiments, presently disclosed methodology may provide for transmitting utility consumption information by way of a cell relay from the plurality of endpoints to the central facility using the primary communications channel and transmitting commonly applicable information to the plurality of endpoints by way of a separate transmitter site using the secondary channel.

In some presently disclosed exemplary embodiments, presently disclosed methodology may provide for transmitting utility consumption related data using frequencies within an industrial, scientific and medical (ISM) frequency band. In other presently disclosed embodiments, such methodology may provide for transmitting commonly applicable information using a relatively higher power transmitter operable at power levels above those permitted in ISM frequency bands.

In certain of the presently disclosed embodiments, the method may provide for transmitting time related signals on the secondary communications channel and/or also other commonly applicable information on the secondary communications channel.

Additional embodiments of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 illustrates a block diagram overview illustrating an Advanced Metering Infrastructure (AMI) incorporating second communications (control) channel technology in accordance with the presently disclosed subject matter;

FIG. 2 is a block diagram overview illustrating, only in part, portions of a known Advanced Metering System (AMS) with which are otherwise practiced devices in which the presently disclosed subject matter may be incorporated and/or presently disclosed methodology practiced;

FIG. 3 illustrates a flow chart outlining the broader aspects of an exemplary communications method in accordance with the presently disclosed subject matter; and

FIG. 4 illustrates an exemplary star network with which the present subject matter may be employed.

Repeat use of reference characters throughout the present specification and appended drawings is intended to represent same or analogous features, elements, or steps.

### DETAILED DESCRIPTION OF THE SUBJECT MATTER

As discussed in the Summary of the Subject Matter section, the presently disclosed subject matter is particularly concerned with the provision of secondary communications channels within AMI networks.

Selected combinations of aspects of the disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

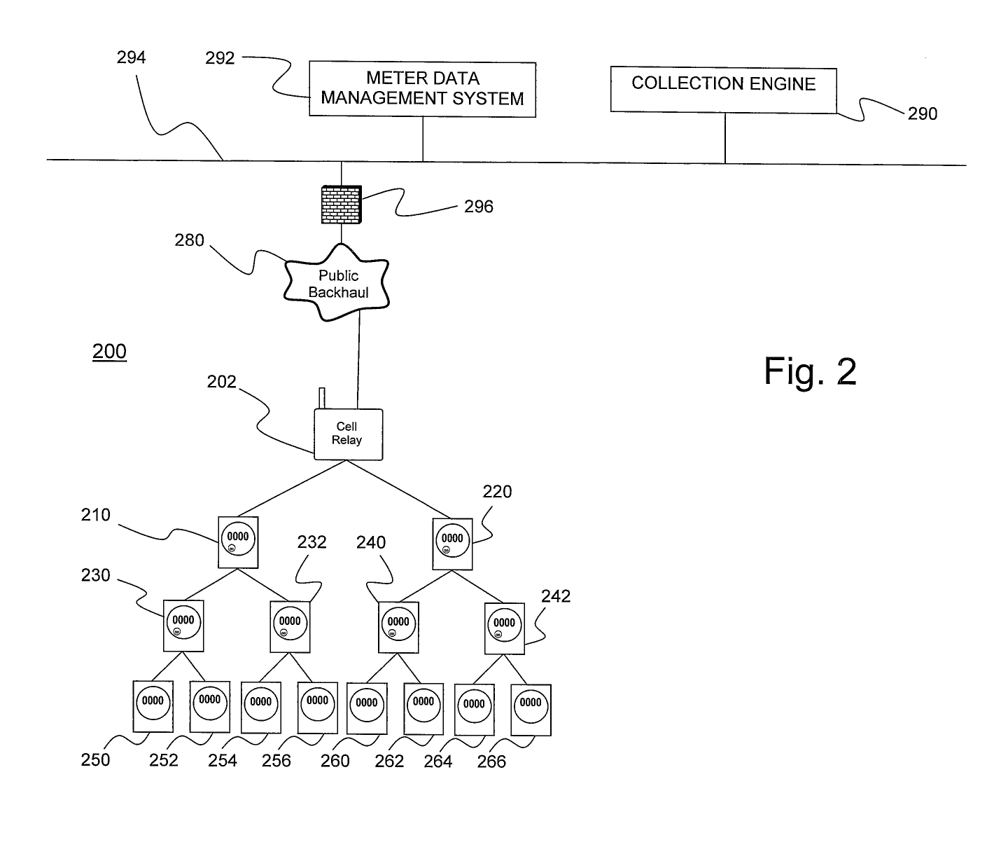

Reference will now be made in detail to the presently preferred embodiments of the subject secondary communications channel within the context of an AMI network. As discussed in the Summary section, the presently disclosed subject matter is particularly concerned with apparatus and methodologies for providing improved communications in a network. Further, it is particularly concerned with improved communications in an automated metrology infrastructure (AMI; also standing for Advanced Metering Infrastructure) environment including secondary communications (control) channel communications. With initial reference to FIG. 2, there is illustrated a block diagram overview illustrating, only in part, a known Advanced Metering System (AMS) 200 illustrating the use of a centralized meter data management system 292. The known aspects of such FIG. 2 illustration primarily relate to the left side thereof, coupled with the public backhaul and related connections to the collection engine, as described in commonly owned published US Patent Application Publication No. 20080068215 A1, the complete disclosure of which is fully incorporated herein by reference for all purposes. It should be understood by those of ordinary skill in the art from the complete disclosure herewith that embodiments of the presently disclosed subject matter (both apparatus and methodology) may involve representations which in and of themselves appear similar to present FIG. 2 but nonetheless which are not comprised of known subject matter.

FIG. 2 illustrates, for exemplary purposes only, a first RF LAN cell, with multiple member nodes organized into three levels. In such exemplary system, respective meter (or metering) devices 210, 220, 230, 232, 240, 242, 250, 252, 254, 256, 260, 262, 264, 266, Cell Relay 202, and Collection Engine 290, preferably have C12.22 network addresses. Meter data management system 292 may be implemented so as to communicate over the Utility LAN 294 to Collection Engine 290 via Web Services. Communications between Cell Relay 202 and Utility LAN 294 variously involve Public Backhaul 280 and firewall 296.

In such exemplary configuration, a meter data acquisition process may begin with the Meter Data Management System 292 initiating a request for data. Such operation may be performed through a web services call to Collection Engine 290 and may in some instances be performed without knowledge of the configured functionality of the end-device. Collection Engine 290 analyzes the request for data, and may preferably formulate a series of multicast (or broadcast) data requests. Such requests are then sent out either directly to the device, or to Cell Relay 202 that relays the message out to all appropriate nodes. Broadcast and multicast messages are sent by Cell Relay 202 to all members of the cell, either via an AMS RF LAN-level broadcast, or by the Cell Relay 202 repeating the message.

In instances when a message is broadcast, multicast, or specifically addressed to an individual network node (meter), a protocol stack for the RF LAN advantageously takes the message and constructs a node path for the message to take before actually transmitting the packet. Such pre-constructed node path allows Cell Relay 202 to push a message down through the tree of the cell without creating redundant radio messages.

As may be seen from the above, all messages between the various meter devices 210, 220, 230, 232, 240, 242, 250, 252, 254, 256, 260, 262, 264, 266, Cell Relay 202, and Collection Engine 290 pass, in both directions through Cell Relay 202. Those of ordinary skill in the art will appreciate that in any such AMS system there may be a number of Cell Relays 202 provided as heads of further RF LAN cells and that such Cell Relays 202 may be associated with other meter devices similar to devices 210, 220, 230, 232, 240, 242, 250, 252, 254, 256, 260, 262, 264, and 266. Such additional Cell Relays 202 would also be configured to provide communications back to and from the same or similar meter data management system 292 and/or collection engine 290, such that the total number of devices may number in the thousands.

Thus, it may be seen that communications conducted through Cell Relay 202 and among the various meter devices may be significantly impacted based on the sheer volume of such communications given the number of devices involved. It would be advantageous, therefore, to provide a mechanism whereby some of the communications may be conducted via other pathways to lessen the load on the network as well as to reduce communications collisions.

Further, as such networks grow in size, more remote endpoints may experience reception problems resulting in repeated transmissions to and from such endpoints that further increase network traffic and add to already existing overload. It would, therefore, also be desirable to provide a mechanism whereby more generally remote devices may be provided additional and/or more reliable opportunity to receive information from the central facility.

In accordance with the presently disclosed subject matter, such network overload may be mitigated, and fringe endpoints with marginal reception may be accommodated, by providing a secondary communications (control) channel that can be used for the downlink of commands and/or information (data) in place of (in addition to) presently used ISM downlinks. Such approach as presently disclosed can off load traffic from, for example, a Time Division Duplexing (TDD) industrial, scientific and medical (ISM) radio network (typically involving relatively lower power transmitters), and thereby increase the effective capacity of the network, by moving common traffic (that is, transmitted information/data commonly applicable to multiple network devices) to the secondary communications (control) channel.

In accordance with the presently disclosed subject matter, such common traffic, that may be transmitted on a secondary communications (control) channel, can also be used for group multicast operations such as demand response as well as, for example, time synchronization of the various network devices. Such secondary communications (control) channel can be implemented as part of the cell control unit (CCU), i.e., Cell Relay, or can be a separate transmitter covering a significantly larger geographic territory. FIG. 2 is representative of presently disclosed subject matter (both apparatus and methodology) where the presently disclosed secondary communications (control) channel is implemented as part of an exemplary Cell Relay.

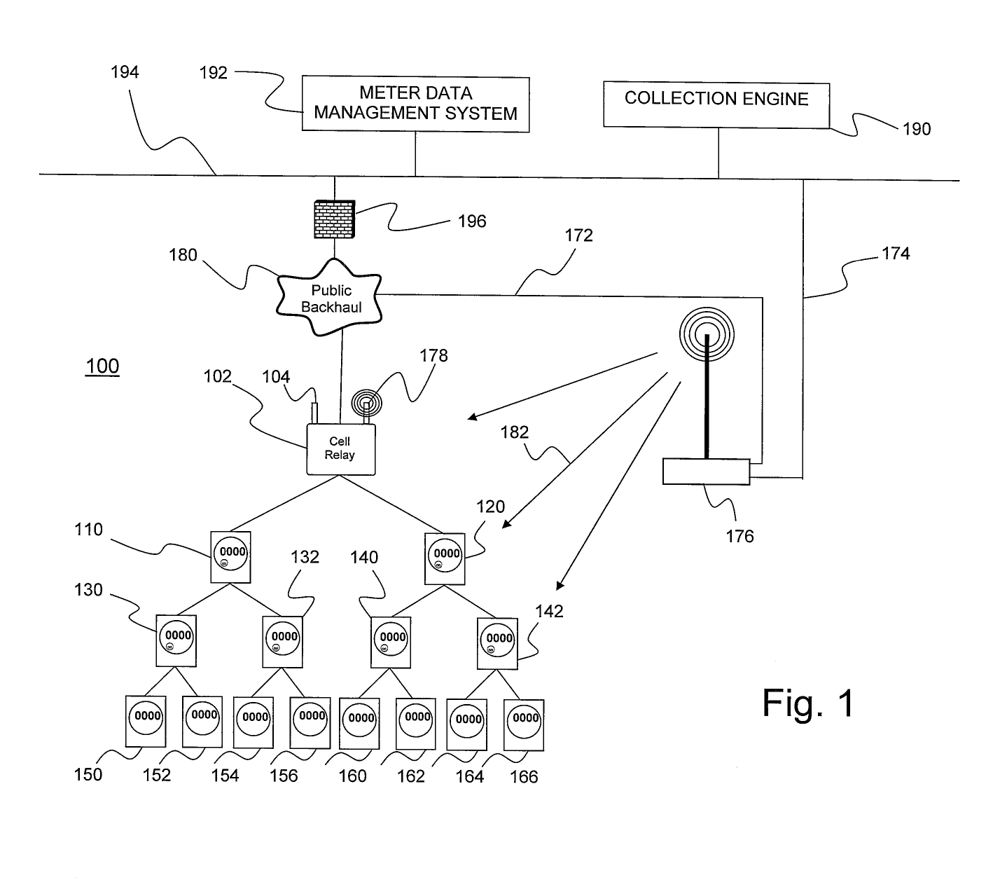

Referring further to the present drawings, FIG. 1 illustrates a block diagram overview illustrating an Advanced Metering Infrastructure (AMI) 100 incorporating second communications (control) channel technology in accordance with the presently disclosed subject matter.

The presently disclosed subject matter in one embodiment thereof may exploit a particular frequency spectrum acquired or licensed by a practitioner of the presently disclosed subject matter but any spectrum may be used that provides for the use of relatively higher transmitter power than presently can be used operating under Title 47 of the Code of Federal Regulations (CFR), Part 15 in the ISM band. In an exemplary configuration, a present exemplary frequency spectrum may correspond to the 931 MHz spectrum and may be used as a downlink to the representative plurality of endpoints (utility meters) 110, 120, 130, 132, 140, 142, 150, 152, 154, 156, 160, 162, 164, and 166 as well as Cell Relay 102 in certain instances, thereby removing the need to perform downlink communications in the ISM band.

In accordance with presently disclosed subject matter, the transmitter for downlink communications over the secondary communications (control) channel can be either associated with Cell Relay 102, or more generally with collectors, CCUs and/or repeaters, using a separate radio represented by antenna 178 as opposed to the otherwise associated ISM radio represented by antenna 104. In the illustration of the presently disclosed subject matter as also represented by present FIG. 2, such representative antenna 178 may be understood to be present, either internally or externally of representative cell relay 202, whether separately illustrated or not. Stated another way, the antenna (unlabeled) per the illustration of present FIG. 2, may be regarded as being representative of both of the antenna illustrated as elements 104 and 178 of present FIG. 1.

Alternatively per presently disclosed subject matter regarding antenna and associated transmitter configurations, because of the relatively very higher transmitter power allowed, such presently disclosed downlink communications may be provided by a separate transmitter site 176 with potentially fewer sites required than collectors for reception. Such separate transmitter site 176 may be provided with communications via direct connection lines 174 and via Utility LAN 194 to Collection Engine 190 and Meter Data Management System 192.

Alternatively, separate transmitter site 176 may be coupled to Utility LAN 194 to Collection Engine 190 and Meter Data Management System 192 via Public Backhaul 180. In either instance, separate transmitter site 176 may transmit relatively higher power signals (representatively radio frequency/RF signal 182) directly to the various utility meters 110, 120, 130, 132, 140, 142, 150, 152, 154, 156, 160, 162, 164, and 166 as well as Cell Relay 102.

Regardless of the transmitter deployment topology utilized, the secondary communications (control) channel per presently disclosed subject matter can offload routine operations, such as the time synchronization of clocks in endpoints, from the ISM radio channels. By constantly or at least periodically broadcasting time related signals on the secondary channel per some embodiments of presently disclosed subject matter, endpoints can periodically correct their clocks by simply tuning to the secondary channel and receiving updated time instead of requiring two-way communications in the ISM band. Such type of presently disclosed, improved operation significantly reduces traffic and congestion in the ISM band.

In electric systems where electricity meters and their associated endpoints are not dependent on battery power for operation as is the situation such as in gas, water, and oil meters (metering devices), the presently disclosed secondary communications channel may be used for unicast and multicast communications, directed to, for example but not limited to, transmitting rates and performing demand response events. Such meters and endpoints not dependent on battery power can always be listening, except during their transmissions periods when, for example, consumption related information may be transmitted.

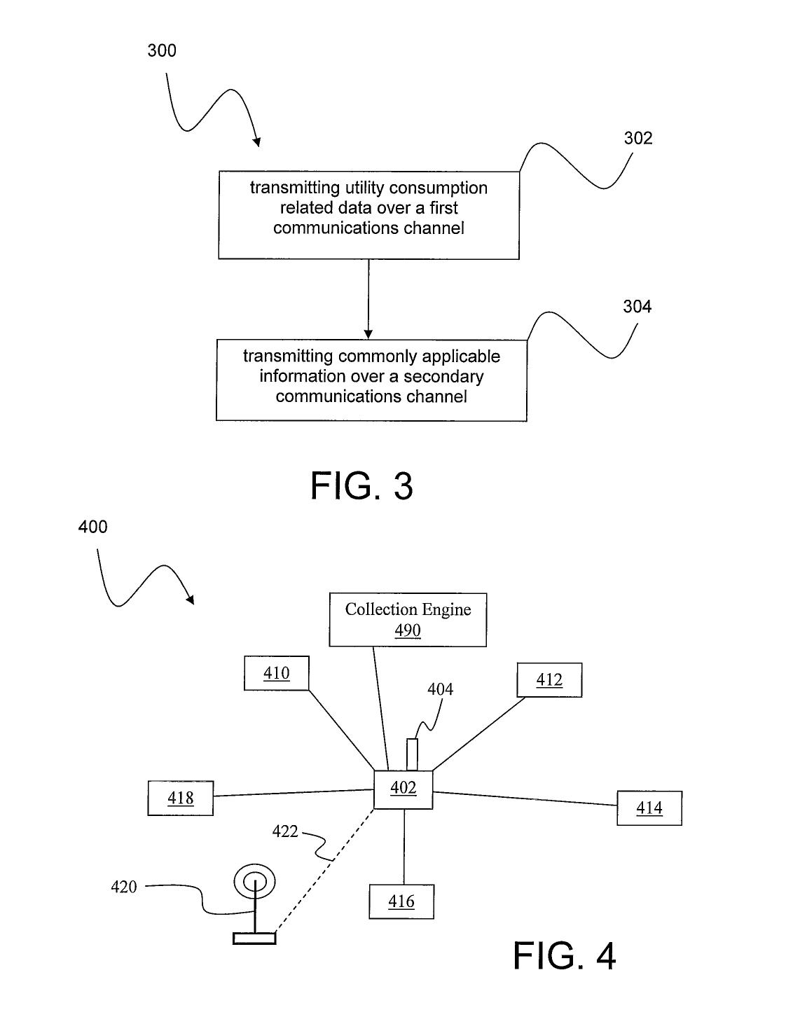

With reference to present FIG. 3, there is illustrated a flow chart generally 300 outlining an exemplary communications methodology in accordance with the presently disclosed subject matter. As generally noted above, the presently disclosed subject matter equally relates to methods for transmitting data and information in a network environment. As illustrated in flow chart 300 of FIG. 3, the illustrated exemplary methodology calls for a first step generally 302 wherein utility consumption data is transmitted over a first communications channel. In such step 302, data from various of the network endpoints may be transmitted to a cell relay, for example, Cell Relay 102 illustrated in FIG. 1 to, for example, collection engine 190. Such transmission is by way of a first communications channel that may by example correspond to a frequency within an ISM band.

Further in accordance with the presently disclosed methodology, as illustrated at step generally 304, information that is commonly applicable to a number of endpoints and even possibly to the cell relay may be transmitted using a second communications channel. In one configuration, the second communication channel may be based in part on a transmitter housed with or within the cell relay. In other embodiments, the second communications channel may be based in part on a physically separate transmitter site that may not be associated with any cell relay or endpoint but may be separately housed altogether and, in general (although not specifically required) located at a relatively central area in relation to all of the various endpoints and cell relays in the network or to some portion thereof. It will be appreciated also that there actually may be more than one second communications channel transmitter within the overall network to further improve communications to the more relatively remote endpoint locations thereof.

With reference to present FIG. 4, there is illustrated an exemplary star network 400 with which the present subject matter may be employed. Often, networks with only battery endpoints will be operated as a star network which may or may not have repeaters. The presently disclosed subject matter is particularly advantageous when used in the context of star networks because in general the operational RF link budget/path loss is much higher for a star network than in a mesh network.

As shown, star network generally 400 includes a central controller 402 with which exemplary endpoints 410, 412, 414, 416, 418 may communicate using a primary communications channel. Central controller 402 is connected to collection engine 490 in a similar manner as is cell relay 202 to collection engine 290. Also, in a fashion similar to that of the system illustrated in FIG. 1, downlink communications may be provided by a separate transmitter site 420 to provide a secondary communications channel such as for providing time and/or control signals separately and directly to endpoints 410, 412, 414, 416, 418. Separate transmitter site 420 may be coupled by communications line 422 to central controller 402. It should be appreciated that communications line 422 may correspond to any suitable communications medium including wireline, optical, radio frequency (RF), or any other suitable communications technology. As in the previously described embodiments, the primary communications may correspond to an ISM band communications technique while the secondary communications channel may correspond to a relatively higher power transmission from separate transmitter 420 or, alternatively, from a second transmitter represented by antenna 404 housed with central controller 402.

While the presently disclosed subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter as would be readily apparent to one of ordinary skill in the art.

What is claimed is:

1. A network, comprising:
a central communications facility;
a plurality of endpoints;
a primary communications channel for communications among said central communications facility and said plurality of endpoints; and
a secondary communications channel for transmitting information commonly applicable to said plurality of endpoints.

2. A network as in claim 1, further comprising:
a cell relay,
wherein said cell relay and at least selected of said plurality of endpoints form a mesh network with said cell relay operating as a control unit for a cell of said mesh network, said cell relay communicating with said plurality of endpoints using said primary communications channel.

3. A network as in claim 2, wherein said cell relay includes a transmitter operating on said secondary communications channel.

4. A network as in claim 1, wherein said primary communications channel is within an industrial, scientific and medical (ISM) frequency band.

5. A network as in claim 1, wherein said secondary communications channel includes a relatively higher power transmitter operable at power levels above those permitted in ISM frequency bands.

6. A network as in claim 1, further comprising a transmitter site including a transmitter operating on said secondary communications channel.

7. A network as in claim 6, wherein said transmitter transmits time related signals on said secondary communications channel.

8. A network as in claim 6, wherein:
said endpoints transmit consumption related data on said primary communications channel; and
said transmitter transmits command signals on said secondary communications channel.

9. A network as in claim 8, wherein said command signals include instructions for said endpoints to transmit said consumption related signals.

10. A network as in claim 1, wherein at least some of said endpoints are respectively associated with metering devices, and said network comprises an Advanced Metering Infrastructure (AMI).

11. A network as in claim 10, wherein said metering devices comprise at least one of electricity, gas, water, and oil meters.

12. A network as in claim 1, wherein:
at least some of said endpoints are respectively associated with electricity metering devices not dependent on battery power for operation; and
said secondary communications channel is used for unicast and multicast communications for transmitting rates and performing demand response events.

13. A network as in claim 1, further comprising:
a cell relay,
wherein said cell relay and at least selected of said plurality of endpoints form a mesh network with said cell relay operating as a control unit for a cell of said mesh network, said cell relay communicating with said plurality of endpoints using said primary communications channel and further including a transmitter operating on said secondary communications channel;
said primary communications channel is within an industrial, scientific and medical (ISM) frequency band;
said secondary communications channel is for relatively higher power transmitter power levels above those permitted in ISM frequency bands;
said endpoints transmit consumption related data on said primary communications channel; and
said cell relay transmitter transmits command signals on said secondary communications channel.

14. A network as in claim 13, wherein at least some of said endpoints are respectively associated with metering devices.

15. A network as in claim 14, wherein:
said metering devices comprise electricity metering devices not dependent on battery power for operation; and
said secondary communications channel is used for unicast and multicast communications for transmitting rates and performing demand response events.

16. A network as in claim 1, further comprising:
a cell relay,
wherein said cell relay and at least selected of said plurality of endpoints form a mesh network with said cell relay operating as a control unit for a cell of said mesh network, said cell relay communicating with said plurality of endpoints using said primary communications channel and further including a transmitter operating on said secondary communications channel;
said primary communications channel is within an industrial, scientific and medical (ISM) frequency band;
said secondary communications channel is for relatively higher power transmitter power levels above those permitted in ISM frequency bands;
said cell relay transmitter transmits time related signals and command signals on said secondary communications channel;
at least some of said endpoints are respectively associated with metering devices; and
said command signals include instructions for said endpoints to transmit consumption related signals.

17. A network as in claim 16, wherein at least some of said metering devices are electricity metering devices not dependent on battery power for operation, and wherein said secondary communications channel is used for unicast and multicast communications for transmitting rates and performing demand response events.

18. A network as in claim 1, further comprising:
a central controller,
wherein said central controller and at least selected of said plurality of endpoints form a star network with said central controller operating as a control unit for said star network, said central controller communicating with said plurality of endpoints using said primary communications channel.

19. A network as in claim 18, wherein said central controller includes a transmitter operating on said secondary communications channel.

20. A network as in claim 1, further comprising:
a central controller,
wherein said central controller and at least selected of said plurality of endpoints form a star network with said central controller operating as a control unit for said star network, said central controller communicating with said plurality of endpoints using said primary communications channel and further including a transmitter operating on said secondary communications channel;
said primary communications channel is within an industrial, scientific and medical (ISM) frequency band;
said secondary communications channel is for relatively higher power transmitter power levels above those permitted in ISM frequency bands;
said endpoints transmit consumption related data on said primary communications channel; and
said central controller transmitter transmits command signals on said secondary communications channel.

21. A network as in claim 20, wherein at least some of said endpoints are respectively associated with metering devices.

22. A network as in claim 21, wherein:
said metering devices comprise electricity metering devices not dependent on battery power for operation; and
said secondary communications channel is used for unicast and multicast communications for transmitting rates and performing demand response events.

23. A network as in claim 1, further comprising:
a central controller,
wherein said central controller and at least selected of said plurality of endpoints form a star network with said central controller operating as a control unit for said star network, said central controller communicating with said plurality of endpoints using said primary communications channel and further including a transmitter operating on said secondary communications channel;
said primary communications channel is within an industrial, scientific and medical (ISM) frequency band;
said secondary communications channel is for relatively higher power transmitter power levels above those permitted in ISM frequency bands;
said central controller transmitter transmits time related signals and command signals on said secondary communications channel;
at least some of said endpoints are respectively associated with metering devices; and
said command signals include instructions for said endpoints to transmit consumption related signals.

24. A network as in claim 23, wherein at least some of said metering devices are electricity metering devices not dependent on battery power for operation, and wherein said secondary communications channel is used for unicast and multicast communications for transmitting rates and performing demand response events.

25. A network communications method, comprising:
transmitting over a primary communications channel utility consumption related data among a plurality of network endpoints and a central facility; and
transmitting commonly applicable information to the plurality of endpoints over a secondary communications channel.

26. A method as in claim 25, further comprising:
transmitting both utility consumption and commonly applicable information by way of a cell relay, such cell relay transmitting utility consumption information from the plurality of endpoints to the central facility using the primary communications channel and transmitting commonly applicable information to the plurality of endpoints using the secondary communications channel.

27. A method as in claim 25, further comprising:
transmitting utility consumption information by way of a cell relay from the plurality of endpoints to the central facility using the primary communications channel; and
transmitting commonly applicable information to the plurality of endpoints by way of a separate transmitter site using the secondary communications channel.

28. A method as in claim 25, wherein transmitting utility consumption related data comprises transmitting utility consumption related data within an industrial, scientific and medical (ISM) frequency band.

29. A method as in claim 25, wherein transmitting commonly applicable information comprises transmitting information using a relatively higher power transmitter operable at power levels above those permitted in ISM frequency bands.

30. A method as in claim 25, wherein transmitting commonly applicable information comprises transmitting time related signals on said secondary communications channel.

31. A method as in claim 25, wherein transmitting commonly applicable information comprises transmitting command signals on said secondary communications channel.

32. A method as in claim 25, wherein at least some of said endpoints are respectively associated with metering devices, and said network communications comprise an Advanced Metering Infrastructure (AMI).

33. A method as in claim 25, wherein said metering devices comprise at least one of electricity, gas, water, and oil meters.

34. A method as in claim 25, wherein:
at least some of said endpoints are respectively associated with electricity metering devices not dependent on battery power for operation; and
said secondary communications channel is used for unicast and multicast communications for transmitting rates and performing demand response events.

35. A method as in claim 25, further comprising including the primary and secondary communications channels in one of a star network and a mesh network.
